(19) United States
(12) Patent Application Publication
(10) Pub. No.: US 2018/0133761 A1
(43) Pub. Date: May 17, 2018

(54) AIR-BLOW CLEANING APPARATUS

(71) Applicant: TOYOTA JIDOSHA KABUSHIKI KAISHA, Toyota-shi (JP)

(72) Inventors: Toshinori OKURA, Toyota-shi (JP); Tomohiro ONO, Toyota-shi (JP)

(73) Assignee: TOYOTA JIDOSHA KABUSHIKI KAISHA, Toyota-shi (JP)

(21) Appl. No.: 15/789,309

(22) Filed: Oct. 20, 2017

(30) Foreign Application Priority Data
Nov. 11, 2016 (JP) 2016-221038

(51) Int. Cl. B08B 5/02; B08B 13/00; B08B 17/02

(52) U.S. Cl. CPC B08B 5/02; B08B 17/02; B08B 13/00

(57) ABSTRACT

An air-blow cleaning apparatus proposed herein includes: a cleaning chamber; a retainer member disposed inside the cleaning chamber; an air circulator configured to generate an airflow flowing from an upside to a downside inside the cleaning chamber; and a blower configured to blow air onto a workpiece retained by the retainer member. An inner wall of the cleaning chamber has a plurality of protrusions or a plurality of recesses, and the protrusions or the recesses are provided at predetermined intervals along an up-and-down direction.

### INCORPORATION BY REFERENCE

The disclosure of Japanese Patent Application No. 2016-221038 filed on Nov. 11, 2016 including the specification, drawings and abstract is incorporated herein by reference in its entirety.

### BACKGROUND

### 1. Technical Field

The present disclosure relates to an air-blow cleaning apparatus.

### 2. Description of Related Art

For example, Japanese Patent Application Publication No. 2007-245126 discloses an related art relating to a dust removing apparatus having a dust removing chamber that has a retainer table on which an object to be treated is retained, an air injection device that blows air onto the object to be treated, and a negative pressure generation device that suctions dust from the dust removing chamber.

### SUMMARY

The present inventors have been considering employing an air-blow cleaning apparatus in the process of cleaning metal workpieces in manufacturing secondary batteries. For example, minute metal fragments produced during processing can adhere to metal members such as the case body, lid, and terminals of a battery case. We hope to remove as much as possible even foreign matters having a size of approximately 100 μm in manufacturing secondary batteries. Cleaning such members with an air-blow cleaning apparatus involves blowing air onto the workpiece so as to blow off minute metal fragments adhering to the workpiece by this air. However, a phenomenon can occur in which minute metal fragments re-adhere to the workpiece by, for example, bouncing off a wall surface of the cleaning chamber.

An air-blow cleaning apparatus proposed herein includes: a cleaning chamber; a retainer member disposed inside the cleaning chamber; an air circulator configured to generate an airflow flowing from an upside to a downside inside the cleaning chamber; and a blower configured to blow air onto a workpiece retained by the retainer member. An inner wall of the cleaning chamber has a plurality of protrusions or a plurality of recesses, the protrusions or the recesses are provided at predetermined intervals along an up-and-down direction. In this air-blow cleaning apparatus, the velocity of foreign matters blown by the blower off the workpiece retained by the retainer member is reduced by the plurality of protrusions or the plurality of recesses provided in the inner wall of the cleaning chamber. Meanwhile, the airflow flowing from the upside to the downside inside the cleaning chamber is generated by the air circulator. Accordingly, the foreign matters having been reduced in velocity are less likely to re-adhere to the workpiece and more likely to fall to and be collected in a lower part of the cleaning chamber.

For example, the inner wall may have a plurality of flat plates, the flat plates may be provided at predetermined intervals along the up-and-down direction so as to protrude into the cleaning chamber. In this case, the flat plates may extend in a direction orthogonal to the inner wall. In this case, the flat plates preferably have a length of, for example, not less than 30 mm and not more than 60 mm in the direction orthogonal to the inner wall. In this case, as seen in a vertical section along the up-and-down direction of the inner wall, a space defined between the flat plates adjacent to each other in the up-and-down direction among the flat plates may have an aspect ratio of not less than 2 and not more than 3.

As an example of the form of the flat plates, the flat plates preferably have a length of not less than 40 mm and not more than 50 mm in the direction orthogonal to the inner wall. As seen in a vertical section along the up-and-down direction of the inner wall, a space defined between the flat plates adjacent to each other in the up-and-down direction among the flat plates preferably has an aspect ratio of not less than 1 and not more than 3.

The form of the protrusions or the recesses provided in the inner wall of the cleaning chamber is not limited to this example. For example, the flat plates that are long in the direction orthogonal to the inner wall and the flat plates that are short in the direction orthogonal to the inner wall may be disposed alternately along the up-and-down direction of the inner wall.

Alternatively, the protrusions or recesses may be formed by a plurality of ridges, the ridges may be provided on the inner wall, except for an upper part and a lower part, at predetermined intervals in the up-and-down direction so as to protrude into the cleaning chamber. In this case, the ridges may be tapered toward leading ends.

The protrusions may be the flat plates.

The flat plates may include a first flat plate and a second flat plate, the first flat plate may be longer than the second flat plate in the direction orthogonal to the inner wall, and the first flat plate and the second flat plate may be disposed alternately along the up-and-down direction of the inner wall.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a sectional view schematically showing an air-blow cleaning apparatus;

FIG. 2 is an enlarged view showing a space A1;

FIG. 3 is a graph showing a relation among an aspect ratio (L1/W1), a velocity of foreign matters after deceleration at inner walls 12c, 12d, and the number of times the foreign matters reflected off the inner walls 12c, 12d;

FIG. 4 is a table showing a relation among a length L1 of flat plates 31, the aspect ratio (L1/W1), and whether a vortex flow was generated (YES) or not generated (NO);

FIG. 5 is a vertical sectional view of the inner wall 12c in another embodiment; and

FIG. 6 is a vertical sectional view of the inner wall 12c in yet another embodiment.

### DETAILED DESCRIPTION OF EMBODIMENTS

An embodiment of an air-blow cleaning apparatus proposed herein will be described below. It should be understood that the embodiment described herein is not intended to limit the present disclosure. Unless otherwise mentioned, the disclosure is not limited to the embodiment described herein. The drawings are schematic views and do not necessarily exactly represent the actual components.

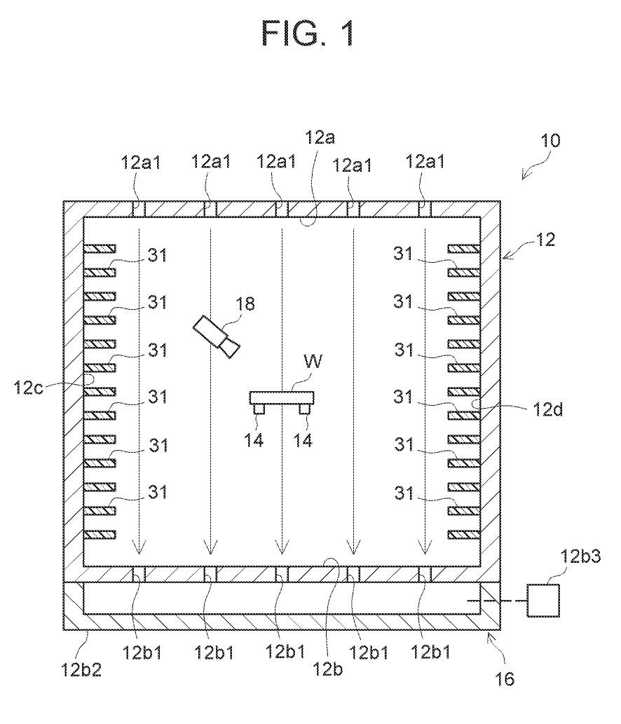

FIG. 1 is a sectional view schematically showing the air-blow cleaning apparatus. As shown in FIG. 1, an air-blow cleaning apparatus 10 includes a cleaning chamber 12, retainer members 14, an air circulator 16, and a blower 18.

As shown in FIG. 1, the cleaning chamber 12 has a cleaning space in which a workpiece W is cleaned, and has side walls that define this cleaning space. In the form shown in FIG. 1, the cleaning chamber 12 has a substantially cuboid cleaning space. In the vertical sectional view of FIG. 1, the side wall on a front side is removed so that the interior of the cleaning chamber 12 is visible.

The retainer members 14 are members that are disposed inside the cleaning chamber 12 and retain the workpiece W to be cleaned. Here, the retainer members 14 preferably have such a structure as can retain the workpiece W without blocking air blown onto the workpiece W by the blower 18. For example, the retainer members 14 may have a structure like that of a robot arm having a grasping part for grasping the workpiece W. In FIG. 1, the workpiece W is disposed roughly at the center of the cleaning chamber 12. However, the position at which the workpiece W is disposed is not limited to the center of the cleaning chamber 12.

The air circulator 16 is a device that generates an airflow flowing from an upside to a downside inside the cleaning chamber 12. In this embodiment, a ceiling 12a of the cleaning chamber 12 has a plurality of air inflow openings 12a1 that extends through the ceiling 12a. A floor 12b has a plurality of air outflow openings 12b1 that extends through the floor 12b. On an outer side of the floor 12b, a chamber 12b2 is provided so as to cover the plurality of air outflow openings 12b1. In the chamber 12b2, a negative pressure creation device 12b3 that creates a negative pressure inside the chamber 12b2 is provided. For example, the negative pressure creation device 12b3 is preferably an air blower that sends air from inside the chamber 12b2 to the outside.

In this embodiment, a negative pressure is created inside the chamber 12b2 by the negative pressure creation device 12b3. When a negative pressure is created inside the chamber 12b2, air inside the cleaning chamber 12 flows out to the chamber 12b2 through the plurality of air outflow openings 12b1 formed in the floor 12b. When the air inside the cleaning chamber 12 flows out to the chamber 12b2, air flows into the cleaning chamber 12 through the plurality of air inflow openings 12a1 formed in the ceiling 12a. As a result, an airflow flowing from an upside to a downside is formed inside the cleaning chamber 12.

The airflow flowing from the upside to the downside formed by the air circulator 16 preferably has a wind velocity of, for example, not less than 4 m/s and not more than 8 m/s (in this embodiment, 6 m/s). A mean value of wind velocities measured with wind power sensors disposed at a plurality of positions inside the cleaning chamber 12 can be evaluated as this wind velocity. Here, the air circulator 16 in this embodiment has been described. The air circulator 16 is not limited to the structure described above but may be any device that generates the airflow flowing from the upside to the downside inside the cleaning chamber 12.

The blower 18 is a device that blows air onto the workpiece W retained by the retainer members 14. For example, the blower 18 is preferably an air blower equipped with a blower fan. Here, to blow off minute foreign matters having a particle size of approximately 100 μm, air blown by the blower 18 preferably has a velocity of, for example, not less than 160 m/s as measured at a nozzle outlet. There is only one blower 18 for the workpiece W in FIG. 1, but a plurality of blowers 18 may instead be provided. For example, the air-blow cleaning apparatus 10 may have a structure in which a plurality of blowers 18 is provided for the workpiece W and these blowers 18 send air to the workpiece W from different angles. Although this is not shown, the blower 18 may be mounted through a moving mechanism so that the position and orientation of an air blow-out port of the blower 18 can be changed relative to the workpiece W. For example, the particle size of foreign matters is a value measured with a particle size distribution measuring device based on a laser scattering diffraction method (e.g., D50 mean value).

Inner walls of the cleaning chamber 12 have a plurality of protrusions or a plurality of recesses, the protrusions or the recesses are provided at predetermined intervals along an up-and-down direction. In this embodiment, inner walls 12c, 12d of the cleaning chamber 12 each have a plurality of flat plates 31 that is provided at predetermined intervals along the up-and-down direction so as to protrude into the cleaning chamber 12. The plurality of flat plates 31 is disposed on an inner side of the side walls extending along the up-and-down direction of the cleaning chamber 12. Although this is not shown, the plurality of flat plates 31 may also be provided in the inner walls of the cleaning chamber 12 on the front side and the rear side in FIG. 1, in addition to those in the inner walls 12c, 12d on the left and right sides. In this embodiment, the plurality of flat plates 31 each extends in a direction orthogonal to the inner walls 12c, 12d.

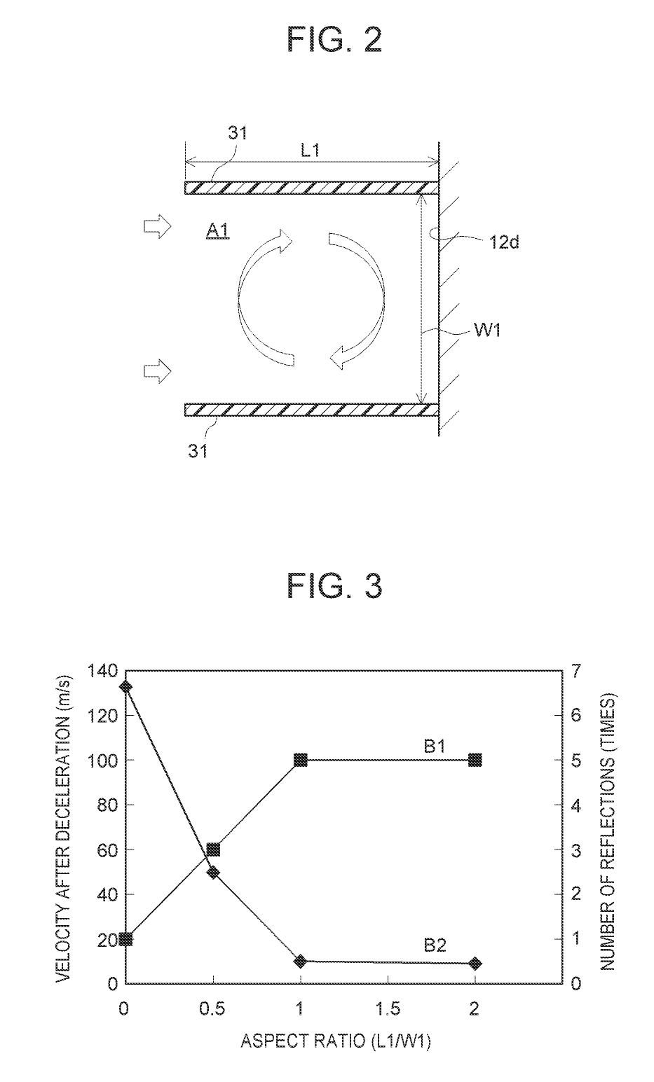

FIG. 2 is an enlarged view showing a space A1 formed between the flat plates 31 adjacent to each other in the up-and-down direction among the plurality of flat plates 31. As shown in FIG. 1 and FIG. 2, foreign matters blown off the workpiece W by air blown from the blower 18 are trapped in the space A1 formed between the flat plates 31 adjacent to each other in the up-and-down direction in the inner walls 12c, 12d of the cleaning chamber 12. Specifically, even when foreign matters are blown off the workpiece W with momentum, once these foreign matters have entered the space A1 formed between the flat plates 31 adjacent to each other in the up-and-down direction in the inner walls 12c, 12d of the cleaning chamber 12, the foreign matters lose their momentum while bouncing inside the space A1, and are thus trapped in the space A1. Accordingly, the foreign matters blown off the workpiece W by air are less likely to re-adhere to the workpiece W. In this embodiment, the flat plate 31 has a thickness of 2 mm. The flat plate 31 preferably has a thickness of, for example, not less than 2 mm and not more than 5 mm.

In this embodiment, the airflow flowing from the upside to the downside is generated inside the cleaning chamber 12 by the air circulator 16. Moreover, air blown by the blower 18 onto the workpiece W also generates an airflow inside the cleaning chamber 12. Part of such airflows enters the space A1 formed between the flat plates 31 adjacent to each other in the up-and-down direction and generates a vortex flow in the space A1. The vortex flow generated in the space A1 formed between the flat plates 31 damps the momentum with which the foreign matters blown off the workpiece W enter the space A1. Moreover, the vortex flow generated in the space A1 causes the foreign matters trapped in the space A1 formed between the flat plates 31 to be gradually discharged from the space A1.

Carried by the airflow flowing from the upside to the downside generated inside the cleaning chamber 12 by the air circulator 16, the foreign matters thus discharged from the space A1 take their own course to fall to the lower part of the cleaning chamber 12 and be collected in the lower part of the cleaning chamber 12. In this embodiment, for example, air flows into the chamber 12b2 through the plurality of air outflow openings 12b1 formed in the lower part of the cleaning chamber 12. The foreign matters ride on this airflow and are collected inside the chamber 12b2. Alternatively, a dust collecting filter may be provided at the plurality of air outflow openings 12b1 to collect foreign matters.

According to findings of the present inventors, through adjustment of the length of the flat plates 31 and the aspect ratio of the space A1, an appropriate vortex flow can be generated in the space A1 defined between the flat plates 31 adjacent to each other in the up-and-down direction. The aspect ratio (L1/W1) of the space A1 is defined, for example, as the ratio between a length L1 of the flat plates 31 and a distance W1 between the flat plates 31 adjacent to each other in the up-and-down direction (L1/W1). An appropriate vortex flow generated in the space A1 defined between the flat plates 31 adjacent to each other in the up-and-down direction can retain foreign matters having entered the space A1 inside the space A1 and reduce the velocity of these foreign matters. Then, the airflow flowing from the upside to the downside generated inside the cleaning chamber 12 by the air circulator 16 allows the foreign matters coming out of the space A1 to fall to the lower part of the cleaning chamber 12.

Here, the present inventors produced the cleaning chambers 12 having the inner walls 12c, 12d with different aspect ratios (L1/W1) of the space A1 defined between the flat plates 31 adjacent to each other in the up-and-down direction by varying the distance W1 between the flat plates 31 adjacent to each other in the up-and-down direction and the length L1 of the flat plates 31. Then, we examined a relation among the aspect ratio (L1/W1), the velocity of foreign matters after deceleration at the inner walls 12c, 12d, and the number of times the foreign matters reflect inside the space A1 defined between the flat plates 31 adjacent to each other in the up-and-down direction. Here, the velocity of foreign matters after deceleration at the inner walls 12c, 12d is, in other words, the velocity of foreign matters moving away from the inner walls 12c, 12d after hitting the inner walls 12c, 12d.

The cleaning chamber 12 and the flat plates 31 can be produced using transparent acrylic plates. A workpiece of a predetermined shape can be disposed inside the cleaning chamber 12 and loaded with a predetermined amount of foreign matters, and these foreign matters can be blown off by air blow.

Then, the inner walls 12c, 12d and peripheries thereof can be photographed with a high-speed camera. The velocity of the foreign matters after deceleration at the inner walls 12c, 12d and the number of times these foreign matters reflect off the inner walls 12c, 12d can be measured based on a video taken with the high-speed camera. Whether a vortex flow is generated in the space A1 or not can be detected, for example, with a microparticle visualization device that employs particle image velocimetry (PIV). For example, a particle image flow velocimeter manufactured by Seika Digital Image Corporation can be used as the microparticle visualization device. We prepared an aluminum workpiece having a predetermined flat plate shape, retained this workpiece horizontally with the retainer members 14 inside the cleaning chamber 12, and disposed a predetermined amount of foreign matters in a flat plate part of the workpiece. Then, we blew air from the blower 18 onto the workpiece under such conditions that the foreign matters were blown off the workpiece, and visually observed whether the foreign matters were re-adhering to the workpiece while illuminating the workpiece.

FIG. 3 is a graph showing the relation among the aspect ratio (L1/W1), the velocity of the foreign matters after deceleration at the inner walls 12c, 12d, and the number of times the foreign matters reflected off the inner walls 12c, 12d. In the graph shown in FIG. 3, the distance W1 between the flat plates 31 adjacent to each other in the up-and-down direction was fixed at 50 mm while the length L1 of the flat plates 31 was varied to vary the aspect ratio (L1/W1) of the space A1. The velocity of the airflow flowing from the upside to the downside generated inside the cleaning chamber 12 by the air circulator 16 was set to 6 m/s. Air was blown onto the workpiece W by the blower 18 with the air velocity at the nozzle outlet adjusted to 160 m/s.

It was confirmed that, under these conditions, the number of reflections increased with the increasing aspect ratio (L1/W1) as indicated by the graph B1. It was also confirmed that the velocity of the foreign matters after deceleration at the inner walls 12c, 12d decreased with the increasing aspect ratio (L1/W1) as indicated by the graph B2. In particular, the phenomenon of foreign matters re-adhering to the workpiece was not recognized when the aspect ratio (L1/W1) was 1 or more.

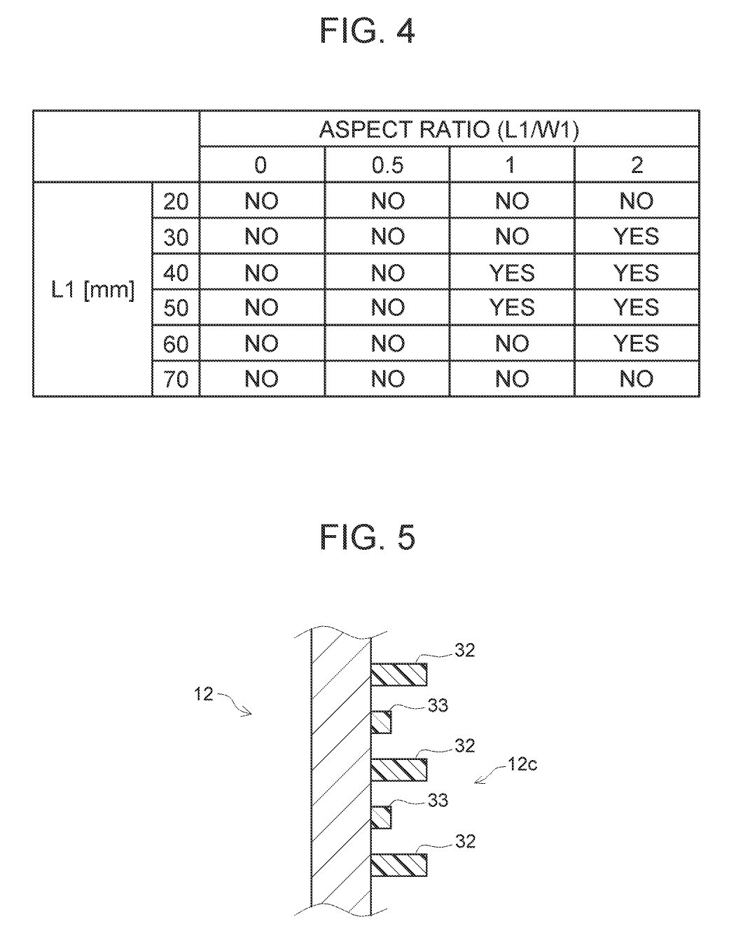

FIG. 4 is a table showing a relation among the length L1 of the flat plates 31, the aspect ratio (L1/W1) of the space A1 defined between the flat plates 31 adjacent to each other in the up-and-down direction, and whether a vortex flow was generated (YES) or not generated (NO). Here, whether a vortex flow was generated in the space A1 or not was examined with the length L1 of the flat plates 31 and the distance W1 between the flat plates 31 adjacent to each other in the up-and-down direction both varied.

In view of the result, the length L1 of the flat plates 31 in the direction orthogonal to the inner walls 12c, 12d is preferably, for example, not less than 30 mm and not more than 60 mm. According to findings of the present inventors, if the length of the flat plates 31 is not less than 30 mm and not more than 60 mm, a vortex flow is more likely to be generated in the space A1 between the flat plates 31, so that foreign matters blown off the workpiece W are more likely to be trapped. Moreover, as seen in a vertical section along the up-and-down direction of the inner walls 12c, 12d, the aspect ratio (L1/W1) of the space A1 defined between the flat plates 31 adjacent to each other in the up-and-down direction among the plurality of flat plates 31 is preferably not less than 2 and not more than 3. According to our findings, if the space A1 is formed so as to have this aspect ratio (L1/W1), foreign matters blown off the workpiece W are even more likely to be trapped. According to our findings, in particular, if the length of the flat plates 31 in the direction orthogonal to the inner walls 12c, 12d is not less than 40 mm and not more than 50 mm, the aspect ratio of the space A1 may be 1 or more.

Thus, the inner walls 12c, 12d of the cleaning chamber 12 preferably have a plurality of protrusions or a plurality of recesses, the protrusions or the recesses are provided at predetermined intervals along the up-and-down direction. Such inner walls 12c, 12d reduce the scattering velocity of foreign matters blown off by the blower 18. Thus, the number of reflections of the foreign matters hitting the inner walls 12c, 12d can be minimized. In this case, the plurality of protrusions or the plurality of recesses are not limited to those formed by the plurality of flat plates 31 provided at predetermined intervals along the up-and-down direction so as to protrude into the cleaning chamber 12. While the plurality of flat plates 31 each extend in the direction orthogonal to the inner walls 12c, 12d in this embodiment, the extension direction of the flat plates 31 is not limited to this example, either.

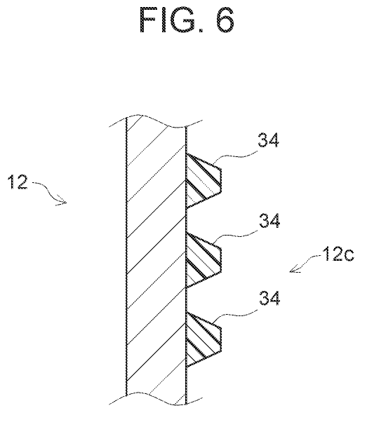

As has been described above, the plurality of protrusions or the plurality of recesses provided in the inner walls 12c, 12d preferably have the function of reducing the velocity of foreign matters blown off the workpiece W. From this viewpoint, the form of the plurality of protrusions or the plurality of recesses provided in the inner walls 12c, 12d is not limited to the example described above. For example, FIG. 5 and FIG. 6 are vertical sectional views of the inner wall 12c in other embodiments. As shown in FIG. 5, in the inner wall 12c of the cleaning chamber 12, flat plates 32 that are long in the direction orthogonal to the inner wall 12c and flat plates 33 that are short in the direction orthogonal to the inner wall 12c may be disposed one after another along the up-and-down direction of the inner wall 12c. That is, the flat plates 32 that are long in the direction orthogonal to the inner wall 12c and the flat plates 33 that are short in the direction orthogonal to the inner wall 12c may be disposed alternately along the up-and-down direction of the inner wall 12c. Alternatively, as shown in FIG. 6, the plurality of protrusions or the plurality of recesses of the inner wall 12c may be formed by a plurality of ridges 34 that are provided at predetermined intervals in the up-and-down direction so as to protrude into the cleaning space. In this case, the ridges 34 may be tapered toward leading ends.

One embodiment of the air-blow cleaning apparatus 10 proposed herein has been described above. As shown in FIG. 1, the air-blow cleaning apparatus 10 proposed herein preferably includes the cleaning chamber 12, the retainer members 14, the air circulator 16, and the blower 18. The retainer members 14 are members that are disposed inside the cleaning chamber 12 and retain the workpiece W. The air circulator 16 is a device that generates the airflow flowing from the upside to the downside inside the cleaning chamber 12. The blower 18 is a device that blows air onto the workpiece W retained by the retainer members 14. The inner walls 12c, 12d of the cleaning chamber 12 have the plurality of protrusions or the plurality of recesses that are provided at predetermined intervals along the up-and-down direction. In the air-blow cleaning apparatus 10, the velocity of foreign matters blown by the blower 18 off the workpiece W retained by the retainer members 14 is reduced by the plurality of protrusions or the plurality of recesses provided in the inner walls 12c, 12d of the cleaning chamber 12. Meanwhile, the airflow flowing from the upside to the downside is generated inside the cleaning chamber 12 by the air circulator 16. Accordingly, the foreign matters having been reduced in velocity are less likely to re-adhere to the workpiece W and more likely to fall to and be collected in the lower part of the cleaning chamber 12. The intervals of the plurality of protrusions or the plurality of recesses provided in the inner wall 12c, 12d are preferably predetermined, and may be set to be constant or irregular.

As shown in FIG. 1, the inner walls 12c, 12d may have the plurality of flat plates 31 that are provided at predetermined intervals along the up-and-down direction so as to protrude into the cleaning chamber 12. In this case, the velocity of the foreign matters blown off is reduced by the space A1 between the flat plates 31 adjacent to each other in the up-and-down direction among the plurality of flat plates 31.

In this case, the flat plates 31 preferably extend in the direction orthogonal to the inner walls 12c, 12d. Moreover, the flat plates 31 preferably have a length of not less than 30 mm and not more than 60 mm in the direction orthogonal to the inner walls 12c, 12d. Thus, a vortex flow is more likely to be generated in the space A1 and the velocity of the foreign matters is more likely to be reduced. In this case, as seen in a vertical section along the up-and-down direction of the inner walls 12c, 12d, the space A1 defined between the flat plates 31 adjacent to each other in the up-and-down direction among the plurality of flat plates 31 preferably has the aspect ratio (L1/W1) of not less than 2 and not more than 3.

When the length of the flat plates 31 in the direction orthogonal to the inner walls 12c, 12d is not less than 40 mm and not more than 50 mm, the aspect ratio of the space A1 may be not less than 1 and not more than 3. In this case, it is especially more likely that a vortex flow is generated in the space A1 and the velocity of the foreign matters is reduced. As shown in FIG. 6, the plurality of protrusions or the plurality of recesses provided in the inner walls 12c, 12d of the cleaning chamber 12 are not limited to the flat plates 31 as shown in FIG. 1.

While various aspects of the air-blow cleaning apparatus proposed herein have been described above, unless otherwise mentioned, the present disclosure is not limited by the embodiment and examples presented herein.

What is claimed is:

1. An air-blow cleaning apparatus comprising:
a cleaning chamber;
a retainer member disposed inside the cleaning chamber;
an air circulator configured to generate an airflow flowing from an upside to a downside inside the cleaning chamber; and
a blower configured to blow air onto a workpiece retained by the retainer member, wherein
an inner wall of the cleaning chamber has a plurality of protrusions or a plurality of recesses, and the protrusions or the recesses are provided at predetermined intervals along an up-and-down direction.

2. The air-blow cleaning apparatus according to claim 1, wherein the inner wall has a plurality of flat plates, and the flat plates are provided at predetermined intervals along the up-and-down direction so as to protrude into the cleaning chamber.

3. The air-blow cleaning apparatus according to claim 2, wherein the flat plates extend in a direction orthogonal to the inner wall.

4. The air-blow cleaning apparatus according to claim 3, wherein the flat plates have a length of not less than 30 mm and not more than 60 mm in the direction orthogonal to the inner wall.

5. The air-blow cleaning apparatus according to claim 4, wherein, as seen in a vertical section along the up-and-down direction of the inner wall, a space defined between the flat plates adjacent to each other in the up-and-down direction among the flat plates has an aspect ratio of not less than 2 and not more than 3.

6. The air-blow cleaning apparatus according to claim 3, wherein
the flat plates have a length of not less than 40 mm and not more than 50 mm in the direction orthogonal to the inner wall, and
as seen in a vertical section along the up-and-down direction of the inner wall, a space defined between the flat plates adjacent to each other in the up-and-down direction among the flat plates has an aspect ratio of not less than 1 and not more than 3.

7. The air-blow cleaning apparatus according to claim 2, wherein the flat plates that are long in a direction orthogonal to the inner wall and the flat plates that are short in the direction orthogonal to the inner wall are disposed alternately along the up-and-down direction of the inner wall.

8. The air-blow cleaning apparatus according to claim 1, wherein
the protrusions or the recesses are a plurality of ridges, the ridges are provided on the inner wall at predetermined intervals in the up-and-down direction so as to protrude into the cleaning chamber, and
the ridges are tapered toward leading ends.

9. The air-blow cleaning apparatus according to claim 2, wherein
the protrusions are the flat plates.

10. The air-blow cleaning apparatus according to claim 2, wherein
the flat plates include a first flat plate and a second flat plate, the first flat plate is longer than the second flat plate in a direction orthogonal to the inner wall, and the first flat plate and the second flat plate are disposed alternately along the up-and-down direction of the inner wall.
